(19) United States
(12) Patent Application Publication
(10) Pub. No.: US 2014/0280328 A1
(43) Pub. Date: Sep. 18, 2014

(54) Database Interface to Create Queries for Multiple Databases

(71) Applicant: PARLANT TECHNOLOGY, INC., Provo, UT (US)

(72) Inventor: Brian Nyman, Eagle Mountain, UT (US)

(73) Assignee: Parlant Technology, Inc., Provo, UT (US)

(21) Appl. No.: 13/871,855

(22) Filed: Apr. 26, 2013

Related U.S. Application Data
(60) Provisional application No. 61/789,222, filed on Mar. 15, 2013.

(51) Int. Cl. G06F 17/30

(52) U.S. Cl. CPC G06F 17/30967
USPC 707/770

(57) ABSTRACT

An apparatus includes a query polling module that sends a request from a local computer to a remote computer. The request includes a request for query update information that is located on and/or is accessible to the remote computer. The local computer is in communication with one or more local databases over a local network. The remote computer is remote from the local network. The apparatus includes, in one embodiment, a query update receiver module that receives query update information from the remote computer and a query update module that updates a set of scheduled queries based on the query update information. The apparatus includes, in another embodiment, an execution module that sends each query of the updated set of scheduled queries to an applicable local database of the one or more local databases, and a results module that receives results of the queries and provides access to the results.

### CROSS-REFERENCE TO RELATED APPLICATION

This application claims the benefit of U.S. Provisional Application No. 61/789,222, which was filed Mar. 15, 2013.

### FIELD

This invention relates to database access and more particularly relates to creating queries for multiple databases.

### BACKGROUND

School districts and other organizations often store data for students, employees, members, etc. in databases. The information stored is often sensitive and requires limited access to maintain confidentiality, to protect financial information and to maintain integrity with the individuals that have information stored in the databases. Often administrators within the organizations that store data do not have time or resources to perform certain tasks associated with the stored data. Often it is more economical for the administrators to hire out specific tasks involving data management, extracting data, generating statistics from the data, notifying parties regarding information stored in the data, etc. Typically companies that are hired to execute these tasks either require access to the databases or require that the administrators create and execute queries to the databases and the send the data to the companies. Allowing access to the data is problematic because it requires allowing the companies access to sensitive information where the tasks performed by the companies may not require such access. Having administrators create and execute queries is problematic because the administrators may not have the expertise to create queries or have to devote time and resource to acquiring a skill that is not in the core expertise of the administrators.

### SUMMARY

An apparatus for database management is disclosed. A system and method also perform the functions of the apparatus. The apparatus includes a query polling module that sends a request from a local computer to a remote computer. The request includes a request for query update information that is located on the remote computer and/or accessible to the remote computer. The local computer is in communication with one or more local databases over a local network and the remote computer is remote from the local network. The apparatus includes, in one embodiment, a query update receiver module that receives query update information from the remote computer and a query update module that updates a set of scheduled queries based on the query update information. The apparatus includes, in another embodiment, an execution module that sends each query of the updated set of scheduled queries to an applicable local database of the one or more local databases, and a results module that receives results of the queries and provides access to the results.

In one embodiment, the query update information includes one or more new queries and also includes a new query module that adds the new queries from the query update information to the set of scheduled queries. The execution module executes the set of scheduled queries and the new queries. The apparatus, in another embodiment, includes a results export module that sends the results of the queries to the remote computer. In another embodiment, the query update information includes scheduling information where the scheduling information is for scheduling the set of scheduled queries and for updated queries in the query update information. In another embodiment, the remote computer includes query update information for two or more local database systems and each set of query update information includes a unique identifier and the query polling module accesses query update information unique to the local databases accessed through the local network using the identifier unique to the local databases of the local network. In one embodiment, the one or more local databases on the local network is a student information system (“SIS”). In another embodiment, the apparatus also includes a backup data module that sends backup data to the remote computer. The backup data includes the set of scheduled queries.

A method for database management includes sending a request from a local computer to a remote computer. The request includes a request for query update information located on the remote computer and the local computer is in communication with one or more local databases over a local network where the remote computer is remote from the local network. The method includes receiving query update information from the remote computer. The query update information includes updates to the set of scheduled queries and/or one or more new queries. The method includes updating a set of scheduled queries based on the query update information, sending at least one query of the updated set of scheduled queries to an applicable local database of the one or more local databases, receiving results of the queries, and providing access to the results. In one embodiment, the method includes sends the results of the queries to the remote computer.

An apparatus for query management includes a query information update module that stores query update information on a remote computer. The query update information includes information to update a scheduled query and/or one or more new queries. The query update information is for updating a set of scheduled queries to one or more local databases available to one or more local computers on a local network where the remote computer is not part of the local network. The apparatus includes a query request receiver module that receives a request for the query update information from a local computer on the local network and a query update transfer module that sends the query update information to the local computer on the local network in response to receiving the request for the query update information.

In one embodiment, the query information update module separately stores query update information for each of two or more local networks with local databases where each instance of query update information includes query update information specific to a particular local network with local databases. In another embodiment, the apparatus includes a common update module that includes common database query information in each instance of query update information. The common database query information includes one or more queries for a specific database type. The common update module includes the common database query information in two or more instances of query update information for local databases with the specific database type. In a further embodiment, the query information update module stores query update information specific to a local network in addition to the common update module including common database query information in the query update information.

In one embodiment, the apparatus includes a results receiver module that receives results from the local computer. The results include query results for queries run on the one or more local databases from the set of scheduled queries that have been updated by the query update information. In a further embodiment, the apparatus includes a result dissemination module that sends a portion of the results to an interested party where the portion of the results that is disseminated is specific to the interested party. In one embodiment, the apparatus includes a notification module that alerts a local computer on a local network when the query update information is changed.

A method for query management includes storing query update information on a remote computer. The query update information includes information to update a scheduled query and/or one or more new queries. The query update information is for updating a set of scheduled queries to one or more local databases available to one or more local computers on a local network where the remote computer is not part of the local network. The method includes receiving a request for the query update information from a local computer on the local network, and sending the query update information to the local computer on the local network in response to receiving the request for the query update information.

In one embodiment, the query update information is separately stored for each of two or more local networks with local databases where each instance of query update information includes query update information specific to a particular local network of the two or more local networks. In another embodiment, the method comprises including common database query information in each instance of query update information. The common database query information includes one or more queries for a specific database type. The method includes the common database query information in two or more instances of query update information for local databases with the specific database type. In another embodiment, the method includes receiving results from the local computer. The results include query results for queries run on the one or more local databases from the set of scheduled queries that have been updated by the query update results.

An apparatus for sending information to mobile device includes a group scheduling module that creates a group. The group includes users of a mobile application that executes on a mobile device where each user is related to an individual with information stored in a database. The apparatus includes a group execution module that enables, at a specified time, one or more queries to the database. The one or more queries are to extract information regarding the individuals related to the group of users of the mobile application. The one or more queries are unavailable for execution prior to the specified time. The apparatus includes a location module that determines that a mobile device with the mobile application executing is within a specified area after the specified time and a trigger module that executes at least one of the one or more queries to the database in response to determining that the location module has determined that the mobile device with the mobile application executing is within the specified area. The executed queries are directed to extracting information from the database regarding the individual related to the user of the mobile device within the specified area. The apparatus includes a mobile transfer module that sends results of the one or more queries executed by the trigger module to the mobile device that the location module determined to be in the specified area after the specified time.

In one embodiment, the apparatus includes a group information module that sends a message along with the results to the mobile device. Each mobile device of a user of the group that receives results also receives the same message. In another embodiment, a user of the mobile application is the same as the individual with information stored in the database. In another embodiment, the information stored in the database is a student information system (“SIS”). In another embodiment, the location module determines that the mobile device is within the specified area by using global positioning system (“GPS”) data. In another embodiment, the location module determines that the mobile device is within the specified area when the mobile device is connected to a wireless network available within the specified area. In yet another embodiment, the apparatus includes a tracking documentation module that, in response to the location module determining that the mobile device is in the specified area after the specified time with the mobile application executing, creates and executes a query to the database to store information that indicates that the user with the mobile device was within the specified area after the specified time.

A method for sending information to mobile device includes creating a group where the group includes users of a mobile application that executes on a mobile device. Each user is related to an individual with information stored in a database. The method includes enabling, at a specified time, one or more queries to the database. The one or more queries are to extract information regarding the individuals related to the group of users of the mobile application. The one or more queries are unavailable for execution prior to the specified time. The method includes determining that a mobile device with the mobile application executing is within a specified area after the specified time and executing at least one of the one or more queries to the database in response to determining that the mobile device with the mobile application executing is within the specified area. The executed queries are directed to extracting information from the database regarding the individual related to the user of the mobile device within the specified area. The method includes sending results of the one or more executed queries to the mobile device determined to be in the specified area after the specified time. In one embodiment, the method includes sending a message along with the results to the mobile device where each mobile device of a user of the group that receives results also receives the same message. In another embodiment, determining that the mobile device is within the specified area includes using global positioning system (“GPS”) data. In another embodiment, determining that the mobile device is within the specified area includes determining that the mobile device is connected to a wireless network available within the specified area.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for database query management in accordance with one aspect the present invention;

FIG. 2 is a schematic block diagram illustrating one embodiment of an apparatus for database query management in accordance with one aspect the present invention;

FIG. 3 is a schematic block diagram illustrating another embodiment of an apparatus for database query management in accordance with one aspect the present invention;

FIG. 4 is a schematic block diagram illustrating one embodiment of an apparatus for query management in accordance with one aspect the present invention;

FIG. 5 is a schematic block diagram illustrating one embodiment of an apparatus for query management in accordance with one aspect the present invention;

FIG. 6 is a schematic block diagram illustrating one embodiment of an apparatus for database query management using a mobile application in accordance with one aspect the present invention;

FIG. 7 is a schematic block diagram illustrating another embodiment of an apparatus for database query management using a mobile application in accordance with one aspect the present invention;

FIG. 8 is a schematic block diagram illustrating one embodiment of a method for database query management from a local system in accordance with one aspect the present invention;

FIG. 9 is a schematic block diagram illustrating one embodiment of a method for database query management from a remote computer in accordance with one aspect the present invention; and

FIG. 10 is a schematic block diagram illustrating one embodiment of a method for database query management using a mobile application in accordance with one aspect the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (“RAM”), a read-only memory (“ROM”), an erasable programmable read-only memory (“EPROM” or Flash memory), a portable compact disc read-only memory (“CD-ROM”), a digital versatile disc (“DVD”), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (“RF”), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers. The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

FIG. 1 is a schematic block diagram illustrating one embodiment of a system 100 for database query management in accordance with one aspect the present invention. The system 100 includes a database management apparatus 102, a mobile device apparatus 104, and a set of scheduled queries 106 in a local computer 108, a local network 110, databases 112a, 112b, . . . 112n (collectively 112), a external network 114, a query management apparatus 116 and query update information 118 in a remote computer 120, and a mobile device 122 in a specified area 124 and in wireless communication 126 with the local network 110, which are described below.

In one embodiment, the system 100 includes a database management apparatus 102 that allows a user to create queries for one or more databases 112 using a graphical user interface (“GUI”) and contacts a remote computer 120 for query update information to update a set of scheduled queries for the databases 112. The database management apparatus 102 will be described in more detail with regards the apparatuses 200, 300 of FIGS. 2 and 3. The system 100 also includes a mobile device apparatus 104 that interfaces with a mobile device application to query the databases 112 and to send information to the mobile device 122 while in the specified area 124. The mobile device apparatus 104, mobile device 122, specified area 124 and wireless communication 126 will be described in more detail with regards the apparatuses 600, 700 of FIGS. 6 and 7. The system 100 also includes a set of scheduled queries 106, which will be described in more detail with regard to the apparatuses 200, 300 of FIGS. 2 and 3.

The database management apparatus 102, the mobile device apparatus 104, and the set of scheduled queries 106 are shown residing on the local computer 108 in FIG. 1, but in various embodiments all or a portion of the database management apparatus 102, the mobile device apparatus 104, and the set of scheduled queries 106 may be located in one or more other locations that are part of a local network 110 or are accessible from the local network 110.

The system 100 includes a local computer 108 connected to a local network 110. The one or more databases 112 are also connected to the local network 110. The local computer 108 may be a laptop computer, desktop computer, a workstation, a server, tablet computer, a mainframe computer, or other computing device capable of connecting to the local network 110. In one embodiment, the local computer 108 accesses the one or more databases 112 through the local network 110. In another embodiment, one or more of the databases 112 reside on the local computer 108.

The local network 110, in one embodiment, includes an external connection to the external network 114. In another embodiment, the local computer 108 connects to the external network 114. The local network 110 may include a local area network (“LAN”), a wide area network (“WAN”), a wireless network, a Bluetooth® network, an optical fiber network, and the like, and may include a combination of networks. The external network 114 connects the remote computer 120 to the local computer 108. In one embodiment, the external network 114 connects the remote computer 120 to the local computer 108 through the local network 110 as shown. The external network 114 may include the Internet, a proprietary network, or other network that is separate from the local network 110. In one embodiment, the external network 114 and the local network 110 are separated by a firewall. The external network 114 may include a wireless network, a fiber optic network, etc. and may be part of a network offered by a local utility, Internet provider, etc. In another embodiment, the local network 110 and external network 114 are part of the same network and are partitioned with a firewall. In another embodiment, the local network 110 and external network 114 are the same network. The local network 110 and external network 114 may include routers, server, switches, cabling, and other equipment common to a computer network.

The one or more databases 112 are accessible through the local network 110. The one or more databases 112 may be of the same type or different types. In one embodiment, the one or more databases 112 are part of a student information system (“SIS”) and include information regarding students in a school district, a college, a trade school, and the like. The student information may include personal data, contact information, class schedules, instructor information, grading information, student grade records, lunch account information, or other information related to a student. In another embodiment, the one or more databases 112 include other information of an organization.

In one embodiment, the databases 112 include different types. For example, one database (e.g. 112a) may be an Aeries® database and may include student contact and grading information while another database (e.g. 112b) may be a Structured Query Language (“SQL”) database with student lunch money information. The one or more databases 112 may be stored on one or more servers that are part of the local network 110 or may be located in remote storage devices accessible to the local network 110. In one embodiment, one or more of the databases 112 may be accessible through a storage area network (“SAN”). One of skill in the art will recognize other configurations and storage options for the one or more databases 112.

In one embodiment, the system 100 includes a query management apparatus 116 located on the remote computer 120 along with query update information 118. The query management apparatus 116 manages query update information that is sent to one or more local networks 110 and is discussed in more detail with regard to the apparatuses 400, 500 of FIGS. 4 and 5. The remote computer 120, in one embodiment, is connected to the local network 110 through the external network 114 and is not part of the local network 110. For example, the local network 110 may be protected by a firewall and the remote computer 120 may interface with the database management apparatus 102 by way of sending query update information rather than directly accessing the one or more databases 112.

In one embodiment, the remote computer 120 is a standalone computer. In another embodiment, the remote computer 120 is part of a network of computers and “remote computer” refers to one or more computers networked together that are remote and/or separate from the local network 110. In the embodiment, functions of the query management apparatus 116 may be distributed among computing devices in the remote network.

The query update information 118 may be located on the remote computer 120 or on another data storage device accessible to the remote computer 120 or remote network. The query update information 118, in one embodiment, is stored together. In another embodiment, the query update information 118 is divided and stored in two or more locations. In one example, the query update information 118 is stored with other query update information from other local networks. In another example, the query update information 118 is stored in a database accessible to the remote computer 120. One of skill in the art will recognize other ways to store and access the query update information 118.

FIG. 2 is a schematic block diagram illustrating one embodiment of an apparatus 200 for database query management in accordance with one aspect the present invention. The apparatus 200 includes one embodiment of the database management apparatus 102 with a query polling module 202, a query update receiver module 204, a query update module 206, an execution module 208, and a results module 210, which are described below.

In one embodiment, the apparatus 200 includes a query polling module 202 that sends a request from the local computer 108 to the remote computer 120. The request includes a request for query update information 118 located on or accessible to the remote computer 120. The local computer 108 is in communication with the one or more local databases 112 over the local network 110 and the remote computer 120 is remote from the local network 110, as describe above in relation the system 100 of FIG. 1. In one embodiment, the query polling module 202 sends the request at a time just before executing queries to the databases 112. In another embodiment, the query polling module 202 sends requests on a more frequent schedule. For example, the query polling module 202 may send requests frequently and the remote computer 120 may ignore the requests unless query update information 118 has changed.

The request typically includes information to identify and distinguish the local network 110 from other local networks. For example, the remote computer 120 may include query update information 118 for two or more local database systems and each set of query update information 118 may include a unique identifier. The query polling module 202 may access query update information 118 unique to the local databases 112 accessed through the local network 110 using the identifier unique to the local databases 112 of the local network 110. The request may be of any form or communication protocol that is recognized by the remote computer 120 and query management apparatus 116. The request may be of any form that would convey information that identifies the local network 110 and that the database management apparatus 102 is seeking query update information 118. In another embodiment, the query polling module 202 responds to a message from the remote computer 120. For example, the remote computer 120 may send out messages and the query polling module 202 may send a request prior to execution of queries. One of skill in the art will recognize other ways for the query polling module 202 to structure and send a request for query update information 118.

In another embodiment, the apparatus 200 includes a query update receiver module 204 that receives query update information 118 from the remote computer 120. In one embodiment, the query update information 118 is in the form of a file. In another embodiment, the query update information 118 includes multiple files.

In another embodiment, the query update information 118 is transmitted by way of a communication protocol and includes information in the form of commands. In one embodiment, the query update information 118 includes scheduling information. The scheduling information may be used for scheduling the set of scheduled queries 106, for example, for queries not being updated, and may also be used for updated queries in the query update information 118 that may update queries in the set of scheduled queries 106.

In one embodiment, the apparatus 200 includes a query update module 206 that updates the set of scheduled queries 106 based on the query update information 118. For example, the set of scheduled queries 106 may be queries received from the query management apparatus 116 and the query update information 118 may make changes or may add additional queries to the set of scheduled queries 106. In another embodiment, some or all of the set of scheduled queries 106 may be created by a user through the database management apparatus 102. Queries created by a user through the database management apparatus 102 may be classified as custom queries and may be distinguished from other queries from the query management apparatus 116 on the remote computer 120.

In one embodiment, the database management apparatus 102 includes a GUI that includes menus and other tools for a user to create a query. The menus and tools, for example, may be suitable for users without advanced knowledge of the structure and form of queries for a particular database (e.g. 112a). In another embodiment, the database management apparatus 102 includes a front end that allows a user to enter information to create a query through a GUI, and also includes various backend components that are each customized for a different database type so that the information input by the user may be converted to a specific, supported protocol of the one or more databases 112. In one embodiment, the query management apparatus 116 updates the database management apparatus 102 to support new database types or new versions of existing database types. In one example, the query management apparatus 116 updates the database management apparatus 102 to support new databases 112 or new versions of databases 112 by including information in the query update information 118. In another embodiment, the query management apparatus 116 updates the database software of the one or more databases 112 through instructions sent by way of the query update information 118. In one embodiment, the query management apparatus 116 manages versions, updates, etc. of the database management apparatus 102 by sending queries, instructions, information, messages, etc. using the query update information 118 sent to the local computer 108 without direct access to the local network 110. One of skill in the art will recognize other ways for the query management apparatus 116 to manage the database management apparatus 102 and one or more databases 112.

In one embodiment, the system 100 includes an execution module 208 that sends each query of the updated set of scheduled queries 106 to an applicable local database (e.g. 112a) of the one or more local databases 112. For example, the queries may be divided by database type and may be sent each to the appropriate database 112.

In another embodiment, one or more of the queries may be scheduled to execute at different times and the execution module 208 may send each of the queries at an appointed time for execution. Typically the queries are executed by the databases 112 and the databases 112 return results of the queries to the results module 210. The results module 210, in one embodiment, receives results of the queries and provides access to the results. For example, users that have access to the database management apparatus 102 may access the results. In another embodiment, the results module 210 sends all or a portion of the results to various parties, such as by email. In another embodiment, the results module 210 sends a notification that the results are available. The database management apparatus 102, in one embodiment, includes a GUI that presents the results to a user in a convenient form. Access to the results by the remote computer 120 and/or query management apparatus 116 is describe below in relation to FIG. 3.

FIG. 3 is a schematic block diagram illustrating another embodiment of an apparatus 300 for database query management in accordance with one aspect the present invention. The apparatus 300 includes another embodiment of the database management apparatus 102 with a query polling module 202, a query update receiver module 204, a query update module 206, an execution module 208, and a results module 210, which are substantially similar to those described above in relation to the apparatus 200 of FIG. 2. The apparatus 300 also includes, in various embodiments, a new query module 302, a results export module 304 and a backup data module 306, which are described below.

In one embodiment, the apparatus 300 includes a new query module 302 that adds the new queries from the query update information 118 to the set of scheduled queries 106. In the embodiment, for example the query update information 118 may include one or more new queries. The new query module 302 may add the new queries to the set of scheduled queries 106. In another embodiment, where the set of scheduled queries 106 does not exist, the new query module 302 may create a set of scheduled queries 106. In another embodiment, the query update information 118 includes new queries along with modifications to existing queries and the new query module 302 adds the new queries to the set of scheduled queries 106 and the query update module 206 updates existing queries in the set of scheduled queries 106.

The new queries, in one embodiment, are queries that are common to multiple local networks 110. For example, the new queries may include information to update one or more databases 112 to a new version, to update the database management apparatus 102, to perform maintenance procedures, etc. The set of scheduled queries 106 may also include common queries that are sent by the query management apparatus 116 to various instances of the query update information 118 to be disseminated to multiple database management apparatuses 102 on various local networks 110. Other queries in the set of scheduled queries 106 and/or new queries may be specific to a particular database management apparatus 102.

In another embodiment, the apparatus 300 includes a results export module 304 that sends the results of the queries to the remote computer 120 and/or the query management apparatus 116. The query management apparatus 116 may use the results to disseminate information from the results to various interested parties. For example, the query management apparatus 116 may use the results to send out messages to parents informing the parents that a child of the parents is missing from class. In another embodiment, the query management apparatus 116 may send statistics generated from the results to school administrators.

In another embodiment, the apparatus 300 includes a backup data module 306 that sends backup data to the remote computer 120. The backup data may include the set of scheduled queries 106. The query management apparatus 116 may store the backup data with query update information 118 for the local network 110 and databases 112. The query management apparatus 116 may use the backup data and/or the query update information 118 to restore data for the database management apparatus 102.

FIG. 4 is a schematic block diagram illustrating one embodiment of an apparatus 400 for query management in accordance with one aspect the present invention. The apparatus 400 includes one embodiment of a query management apparatus 116 with a query information update module 402, a query request receiver module 404, and a query update transfer module 406, which are described below.

The apparatus 400 includes, in one embodiment, a query information update module 402 that stores query update information 118 on the remote computer 120. The query update information 118 includes information to update a scheduled query and/or one or more new queries. The query update information 118 is for updating a set of scheduled queries 106 to one or more local databases 112 available to one or more computers on a local network 110. The remote computer 120 is not a part of the local network 110. For example, the query information update module 402 may separately store query update information 118 for each of two or more local networks with local databases where each instance of query update information 118 includes query update information 118 specific to a particular local network (e.g. 110) with local databases (e.g. 112).

In one embodiment, the query information update module 402 updates the query update information 118 with original queries. In another embodiment, the query information update module 402 updates the query update information 118 with query update information 118 from another database management apparatus or local network.

In another embodiment, the query information update module 402 updates the query update information 118 with query update information 118 from a different database management apparatus that has been modified. In another embodiment, the query information update module 402 updates the query update information 118 with previously stored query update information 118 from the database management apparatus 102 being updated after the database management apparatus 102 has lost data. In the embodiment, other backup data may also be included.

In one embodiment, the apparatus 400 includes a query request receiver module 404 that receives a request for the query update information 118 from a computer on the local network 110, for example from the database management apparatus 102 on the local computer 108. The request may be the same as the request sent by the query polling module 202 as described above. In one embodiment, the query request receiver module 404 receives the request independent of a communication sent by the query management apparatus 116. In another embodiment, the query request receiver module 404 receives the request in response to a communication from the query management apparatus 116. Typically the request will identify the particular local network 110, database management apparatus 102, and or databases 112 from which the request originated. The request may include a unique identifier.

The apparatus 400, in another embodiment, includes a query update transfer module 406 that sends the query update information 118 to the local computer 108 on the local network 110 in response to receiving the request for the query update information 118. The query update transfer module 406 may send the query update information 118 as a file, as block data using a small computer system interface (“SCSI”) protocol, in a remote direct memory access (“RDMA”) data transfer, as an object or other method known to those of skill in the art. The query update information 118 may include queries or may include instructions and/or commands to create or modify existing queries. One of skill in the art will recognize other ways to create query update information 118 and to send the query update information 118.

FIG. 5 is a schematic block diagram illustrating one embodiment of an apparatus 500 for query management in accordance with one aspect the present invention. The apparatus 500 includes another embodiment of a query management apparatus 116 with a query information update module 402, a query request receiver module 404, and a query update transfer module 406, which are substantially similar to those described above in relation to the apparatus 400 of FIG. 4. The apparatus 500 includes, in various embodiments, a common update module 502, a results receiver module 504, a results dissemination module 506, and a notification module 508, which are described below.

The apparatus 500 includes, in one embodiment, a common update module 502 that includes common database query information in each instance of query update information 118, for example, for multiple database managements apparatuses 102. The common database query information includes one or more queries for a specific database type. For example, where several of the local databases 112 are Aeries® databases of a particular version on various local networks 110, the common update module 502 may include queries or updates for queries in the query update information for the local networks with Aeries databases. The common update module 502 includes the common database query information in two or more instances of query update information 118 for local databases 112 with the specific database type. The common update module 502 may allow the query management apparatus 116 to update multiple databases 112 or issue identical queries to multiple databases 112, which may be more efficient than individually updating query update information 118 one at a time. The common update module 502, for example, may have information about each type and version of database 112 serviced by the query management apparatus 116 and may push out updates in an automated manner by database type. One of skill in the art will recognize other ways that the common update module 502 may update each instance of query update information 118 with a common update for databases of a like type.

The apparatus 500 includes, in another embodiment, a results receiver module 504 that receives results from the local computer 108. The results include query results for queries run on the one or more local databases 112 from the set of scheduled queries 106 that have been updated by the query update information 118. The results receiver module 504 may receive the results autonomously or may receive the results after a communication to the database management apparatus 102 sending the results.

The apparatus 500 also includes, in one embodiment, a result dissemination module 506 that sends a portion of the results to an interested party where the portion of the results sent is specific to the interested party. For example, the result dissemination module 506 may retrieve attendance data from the results and may notify a parent that a child is not in class. In another example, the result dissemination module 506 may send grades to parents of students where the grading information was part of the results.

The apparatus 500 also may include, in one embodiment, a notification module 508 that alerts a local computer 108 on a local network 110 when the query update information is changed. For example, rather than waiting for the query polling module 202 to send a request to the remote computer 120, the notification module 508 may proactively notify the database management apparatus 102 on the local network 110 that the query update information 118 has changed. The query polling module 202 may then send a request for the changed query update information 118 in response to receiving the notification from the notification module 508.

FIG. 6 is a schematic block diagram illustrating one embodiment of an apparatus 600 for database query management using a mobile application in accordance with one aspect the present invention. The apparatus 600 includes one embodiment of the mobile device apparatus 104 with a group scheduling module 602, a group execution module 604, a location module 606, a trigger module 608, and a mobile transfer module 610, which are described below.

The apparatus 600 includes, in one embodiment, a group scheduling module 602 that creates a group where the group includes users of a mobile application that executes on a mobile device 122. Each user is related to an individual with information stored in a database 112. For example, the group scheduling module 602 may include a group of parents of students for a particular teacher or a group of parents of students that are in a particular grade. At least some of the parents may each have a mobile device 122, such as a Smartphone or tablet computer, that is capable of running a mobile application. In one embodiment the user is the same as the individual with information stored in the database 112. For example, a student may have a mobile device 122 with the mobile application installed. The group scheduling module 602 may create a group related to a specific event, such as parent-teacher conferences or distribution of grades. The event may also be a current event in the news or special event at a school.

The apparatus 600, in another embodiment, includes a group execution module 604 that enables, at a specified time, one or more queries to the database 112. The one or more queries are to extract information regarding the individuals related to the group of users of the mobile application. In one embodiment, the one or more queries are unavailable for execution prior to the specified time. For example, the specified time may be a starting time for parent teacher conferences or at the start of an event or a certain time before the event. The group scheduling module 602 may create a group prior to the specified time and the group execution module 604 may also create the queries before the specified time. The group execution module 604 then prevents execution prior to the specified time.

The apparatus 600 includes, in another embodiment, a location module 606 that determines that a mobile device 122 with the mobile application executing is within a specified area 124 after the specified time. For example, the location module 606 may determine that a parent has entered the school on the night of scheduled parent-teacher conferences. In one embodiment, the location module 606 uses global positioning system (“GPS”) data to determine that the mobile device 122 is within the specified area 124. In another example, the location module 606 determines that the mobile device 122 is within the specified area 124 by determining that the mobile device is connected to a wireless network available within the specified area 124. For example, the wireless network may be WiFi network, a Bluetooth® network, a near field communication (“NFC”) network, or the like. In one embodiment, the mobile application sends a communication when within the specified area 124. In another embodiment, the location module 606 detects that the mobile device 122 is within the specified area 124.

In one embodiment, the apparatus 600 includes a trigger module 608 that executes at least one of the one or more queries to the database 112 in response to determining that the location module 606 has determined that the mobile device 122 with the mobile application executing is within the specified area 124. The executed queries are directed to extracting information from the database 112 regarding the individual related to the user of the mobile device 122 within the specified area 124. For example, after the location module 606 determines that the mobile device 122 the mobile application executing is within the specified area 124 and after the specified time, the trigger module 608 then executes queries to retrieve information from the database 112 for to the individual related to the user of the mobile device 122. For instance, a parent visiting a teacher during parent-teacher conferences may be within the specified area 124, such as the school, a Bluetooth or NFC network in the classroom, etc. and the trigger module 608 may then retrieve grading information for the student of the parent. In another example, a counselor may have an appointment set up with a student and the location module 606 may determine that the student has entered the office of the counselor at the appointment time. The trigger module 608 may execute queries to retrieve data for the student that is located in the database 112.

The apparatus 600 includes, in another embodiment, a mobile transfer module 610 that sends results of the one or more queries executed by the trigger module 608 to the mobile device 122 that the location module 606 determined to be in the specified area 124 after the specified time. For example, once the trigger module 606 has retrieved student grading information, the mobile transfer module 610 may send the grading information to the parent that attended the parent-teacher conference. In another embodiment, the mobile transfer module 610 sends a copy to another individual, such as the teacher. In another embodiment, the mobile transfer module 610 keeps a log of information sent, users to which the information was sent, etc.

In one embodiment, the specified time includes a starting time and an ending time. For example, the specified time for an event may begin at the start of the event and may end at the end of the event. In another example, the specified time may start at the beginning of parent-teacher conferences and may end at the end of parent-teacher conferences. In one embodiment the specific time varies from user to user within the group. For example, for parent-teacher conferences, a specific time for a user may start at the beginning of a scheduled time for a parent. The specific time may also end at the end of the scheduled time for the parent. In one embodiment, the information stored in the database is part of a student information system (“SIS”).

FIG. 7 is a schematic block diagram illustrating another embodiment of an apparatus 700 for database query management using a mobile application in accordance with one aspect the present invention. The apparatus 700 includes another embodiment of the mobile device apparatus 104 with a group scheduling module 602, a group execution module 604, a location module 606, a trigger module 608, and a mobile transfer module 610, which are substantially similar to those described above with regard to the apparatus 600 of FIG. 6. The apparatus 700, in various embodiments, includes a group information module 702 and a tracking documentation module 704, which are described below.

The apparatus 700, in one embodiment, includes a group information module 702 that sends a message along with the results to the mobile device 122, where each mobile device 122 of a user of the group that receives results receives the same message. For example, the mobile transfer module 610 may send results specific to the individual with information stored on the database 112 and the group information module 702 may include a message intended to be sent to all users in the group. For instance, the group information module 702 may send a school newsletter or instructions associated with the event related to the specific time or related to the reason the mobile device 122 is in the specified area 124.

In another embodiment, the apparatus 700 includes a tracking documentation module 704 that, in response to the location module 606 determining that the mobile device 122 is in the specified area 124 after the specified time with the mobile application executing, creates and executes a query to the database 112 to store information that indicates that the user with the mobile device 122 was within the specified area 124 after the specified time. In one embodiment, the information is stored with other information regarding the individual related to the user. In another embodiment, the information is stored in a different location. The tracking documentation module 704 may be used to log which users received the results sent by the mobile transfer module 610. Administrators may then use the information to track attendance at an event, may use the information to determine which other users need to receive information, etc.

FIG. 8 is a schematic block diagram illustrating one embodiment of a method 800 for database query management from a local system in accordance with one aspect the present invention. The method 800 begins and sends 802 a request from a local computer 108 to a remote computer 120. The request includes a request for query update information 118 located on the remote computer 120. The local computer 108 is in communication with one or more local databases 112 over a local network 110. The remote computer 120 is remote from the local network 110 and is not part of the local network 110. The method 800 receives 804 query update information 118 from the remote computer 120 and updates 806 a set of scheduled queries 106 based on the query update information 118. The query update information 118 includes updates to the set of scheduled queries 106 and/or one or more new queries. The method 800 sends 808 each query of the updated set of scheduled queries 106 to an applicable local database of the one or more local databases 112, receives 810 results of the queries, and provides 812 access to the results, and the method 800 ends. In one embodiment, the method 800 also sends the results of the queries to the remote computer 120. In various embodiments, the method 800 uses one or more modules 202-210, 302-306 of the apparatuses 200, 300 of FIGS. 2 and 3.

FIG. 9 is a schematic block diagram illustrating one embodiment of a method 900 for database query management from a remote computer in accordance with one aspect the present invention. The method 900 begins and stores 902 query update information 118 on a remote computer 120. The query update information 118 includes information to update a scheduled query and one or more new queries. The query update information 118 is for updating a set of scheduled queries 106 to one or more local databases 112 available to one or more local computers 108 on a local network 110 and the remote computer 120 is not part of the local network 110. The method 900 receives 904 a request for the query update information 118 from a local computer 108 on the local network 110 and sends 906 the query update information 118 to the local computer 108 on the local network 110 in response to receiving the request for the query update information 118, and the method 900 ends.

In one embodiment, the query update information 118 is separately stored for each of two or more local networks 110 with local databases 112 and each instance of query update information 118 includes query update information 118 specific to a particular local network 110 of the two or more local networks. In another embodiment, the method 900 includes common database query information in each instance of query update information 118. The common database query information includes one or more queries for a specific database type and the method 900 includes the common database query information at least two instances of query update information 118 that the method 900 sends to the local databases 112 with the specific database type. The method 900, in another embodiment, includes receiving results from the local computer 108 where the results include query results for queries run on the one or more local databases 112 from the set of scheduled queries 106 that have been updated by the query update information 118. In various embodiments, the method 900 uses one or more modules 402-406, 502-508 of the apparatuses 400, 500 of FIGS. 4 and 5.

FIG. 10 is a schematic block diagram illustrating one embodiment of a method 1000 for database query management using a mobile application in accordance with one aspect the present invention. The method 1000 begins and creates 1002 a group where the group includes users of a mobile application that executes on a mobile device 122 and each user is related to an individual with information stored in a database 112. The method 1000 enables 1004, at a specified time, one or more queries to the database 112. The queries are to extract information regarding the individuals related to the group of users of the mobile application. The method 1000 makes the one or more queries unavailable for execution prior to the specified time.

The method 1000 determines 1006 that a mobile device 122 with the mobile application executing is within a specified area 124 after the specified time and executes 1008 at least one of the queries to the database 112 after determining 1006 that the mobile device 122 with the mobile application executing is within the specified area 124. The executed queries are directed to extracting information from the database 112 regarding the individual related to the user of the mobile device 122 within the specified area 124. The method 1000 sends 1010 results of the executed queries to the mobile device 122 determined to be in the specified area 124 after the specified time. The method 1000 may also send a message along with the results to the mobile device 122 each mobile device 122 of a user of the group that receives results receives the same message. In various embodiments, the method 1000 uses one or more modules 602-610, 702-704 of the apparatuses 600, 700 of FIGS. 6 and 7.

In many of the embodiments of the system 100, apparatuses 200, 300, 400, 500, 600, 700 and methods 800, 900, 1000 discussed above, many examples are related to education and a student information system. One of skill in the art will recognize that the embodiments of the invention disclosed herein are not limited to educational uses but may be used for other organizations where information is stored in one or more databases, and also for organizations where the stored data is sensitive in nature. For example, medical offices, financial offices, governmental offices, and the like may benefit from the embodiments of the invention disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a query polling module that sends a request from a local computer to a remote computer, the request comprising a request for query update information that is one of located on the remote computer and accessible to the remote computer, the local computer in communication with one or more local databases over a local network, the remote computer being remote from the local network;
a query update receiver module that receives query update information from the remote computer;
a query update module that updates a set of scheduled queries based on the query update information;
an execution module that sends each query of the updated set of scheduled queries to an applicable local database of the one or more local databases; and
a results module that receives results of the queries and provides access to the results,
wherein at least a portion of the query polling module, the query update receiver module, the query update module, the execution module, and the results module comprise one or more of hardware and executable code, the executable code stored on one or more computer readable storage media.

2. The apparatus of claim 1, wherein the query update information includes one or more new queries and further comprising a new query module that adds the new queries from the query update information to the set of scheduled queries and wherein the execution module executes the set of scheduled queries and the new queries.

3. The apparatus of claim 1, further comprising a results export module that sends the results of the queries to the remote computer.

4. The apparatus of claim 1, wherein the query update information includes scheduling information, the scheduling information for scheduling the set of scheduled queries and for updated queries in the query update information.

5. The apparatus of claim 1, wherein the remote computer includes query update information for two or more local database systems and wherein each set of query update information includes a unique identifier and the query polling module accesses query update information unique to the local databases accessed through the local network using the identifier unique to the local databases of the local network.

6. The apparatus of claim 1, wherein the one or more local databases on the local network comprises a student information system (“SIS”).

7. The apparatus of claim 1, further comprising a backup data module that sends backup data to the remote computer, the backup data comprising the set of scheduled queries.

8. A method comprising:
sending a request from a local computer to a remote computer, the request comprising a request for query update information located on the remote computer, the local computer in communication with one or more local databases over a local network, the remote computer being remote from the local network;
receiving query update information from the remote computer;
updating a set of scheduled queries based on the query update information, the query update information comprising one or more of updates to the set of scheduled queries and one or more new queries;
sending each query of the updated set of scheduled queries to an applicable local database of the one or more local databases;
receiving results of the queries; and
providing access to the results.

9. The method of claim 8, further comprising sending the results of the queries to the remote computer.

10. An apparatus comprising:
a query information update module that stores query update information on a remote computer, the query update information comprising one or more of information to update a scheduled query and one or more new queries, the query update information for updating a set of scheduled queries to one or more local databases available to one or more local computers on a local network, the remote computer not part of the local network;
a query request receiver module that receives a request for the query update information from a local computer on the local network; and
a query update transfer module that sends the query update information to the local computer on the local network in response to receiving the request for the query update information.

11. The apparatus of claim 10, wherein the query information update module separately stores query update information for each of two or more local networks with local databases wherein each instance of query update information includes query update information specific to a particular local network with local databases.

12. The apparatus of claim 11, further comprising a common update module that includes common database query information in each instance of query update information, the common database query information comprising one or more queries for a specific database type, the common update module including the common database query information in two or more instances of query update information for local databases with the specific database type.

13. The apparatus of claim 12, wherein the query information update module stores query update information specific to a local network in addition to the common update module including common database query information in the query update information.

14. The apparatus of claim 10, further comprising a results receiver module that receives results from the local computer, the results comprising query results for queries run on the one or more local databases from the set of scheduled queries that have been updated by the query update information.

15. The apparatus of claim 14, further comprising a result dissemination module that sends a portion of the results to an interested party, the portion of the results being specific to the interested party.

16. The apparatus of claim 10, further comprising a notification module that alerts a local computer on a local network when the query update information is changed.

17. A method comprising:
storing query update information on a remote computer, the query update information comprising one or more of information to update a scheduled query and one or more new queries, the query update information for updating a set of scheduled queries to one or more local databases available to one or more local computers on a local network, the remote computer not part of the local network;
receiving a request for the query update information from a local computer on the local network; and
sending the query update information to the local computer on the local network in response to receiving the request for the query update information.

18. The method of claim 17, wherein the query update information is separately stored for each of two or more local networks with local databases wherein each instance of query update information includes query update information specific to a particular local network of the two or more local networks.

19. The method of claim 18, further comprising including common database query information in each instance of query update information, the common database query information comprising one or more queries for a specific database type, wherein the method includes the common database query information in two or more instances of query update information for local databases with the specific database type.

20. The method of claim 17, further comprising receiving results from the local computer, the results comprising query results for queries run on the one or more local databases from the set of scheduled queries that have been updated by the query update results.

21. An apparatus comprising:
a group scheduling module that creates a group, the group comprising users of a mobile application that executes on a mobile device, each user related to an individual with information stored in a database;
a group execution module that enables, at a specified time, one or more queries to the database, the one or more queries to extract information regarding the individuals related to the group of users of the mobile application, the one or more queries being unavailable for execution prior to the specified time;
a location module that determines that a mobile device with the mobile application executing is within a specified area after the specified time;
a trigger module that executes at least one of the one or more queries to the database in response to determining that the location module has determined that the mobile device with the mobile application executing is within the specified area, the executed queries directed to extracting information from the database regarding the individual related to the user of the mobile device within the specified area; and
a mobile transfer module that sends results of the one or more queries executed by the trigger module to the mobile device that the location module determined to be in the specified area after the specified time.

22. The apparatus of claim 21, further comprising a group information module that sends a message along with the results to the mobile device, wherein each mobile device of a user of the group that receives results receives a message with the same message body as the message received by other users of the group.

23. The apparatus of claim 21, wherein a user of the mobile application is the same as the individual with information stored in the database.

24. The apparatus of claim 21, wherein the information stored in the database comprises a student information system (“SIS”).

25. The apparatus of claim 21, wherein the location module determines that the mobile device is within the specified area by using global positioning system (“GPS”) data.

26. The apparatus of claim 21, wherein the location module determines that the mobile device is within the specified area when the mobile device is connected to a wireless network available within the specified area.

27. The apparatus of claim 21, further comprising a tracking documentation module that, in response to the location module determining that the mobile device is in the specified area after the specified time with the mobile application executing, creates and executes a query to the database to store information that indicates that the user with the mobile device was within the specified area after the specified time.

28. A method comprising:
creating a group, the group comprising users of a mobile application that executes on a mobile device, each user related to an individual with information stored in a database;
enabling, at a specified time, one or more queries to the database, the one or more queries to extract information regarding the individuals related to the group of users of the mobile application, the one or more queries being unavailable for execution prior to the specified time;
determining that a mobile device with the mobile application executing is within a specified area after the specified time;
executing at least one of the one or more queries to the database in response to determining that the mobile device with the mobile application executing is within the specified area, the executed queries directed to extracting information from the database regarding the individual related to the user of the mobile device within the specified area; and
sending results of the one or more executed queries to the mobile device determined to be in the specified area after the specified time.

29. The method of claim 28, further comprising sending a message along with the results to the mobile device, wherein each mobile device of a user of the group that receives results receives the same message.

30. The method of claim 28, wherein determining that the mobile device is within the specified area comprises using global positioning system (“GPS”) data.

31. The method of claim 28, wherein determining that the mobile device is within the specified area comprises determining that the mobile device is connected to a wireless network available within the specified area.
